(19) United States
(12) Patent Application Publication
(10) Pub. No.: US 2024/0402921 A1
(43) Pub. Date: Dec. 5, 2024

(54) DETERMINING OPTIMAL COMPONENTS OF A STORAGE SUBSYSTEM BASED ON MEASUREMENTS AND MODELS

(71) Applicant: INTERNATIONAL BUSINESS MACHINES CORPORATION, Armonk, NY (US)

(72) Inventors: Georg Basil Richard Moshous, Unterföhring (DE); Adriana Pellegrini Furnielis, Valinhos (BR); Marc Henri Coq, Hopewell Junction, NY (US); Sarvesh S. Patel, Pune (IN); Ebenezer Kofi, Duluth, GA (US)

(21) Appl. No.: 18/328,105

(22) Filed: Jun. 2, 2023

(51) Int. Cl. G06F 3/06

(52) U.S. Cl. CPC G06F 3/0629; G06F 3/0604; G06F 3/0679

(57) ABSTRACT

Provided are techniques for model generation for determining optimal components of a storage subsystem based on measurements and models. Data for a storage subsystem having a plurality of components is collected, where the data comprises data for application resources, data for workload measurements, metadata, tags, and policies, and wherein the data comprises volume specific characteristics and storage functions. A plurality of models are generated based on the collected data, where each of the models includes a subset of the plurality of components of the storage subsystem. Characteristics for a new storage subsystem are received. The characteristics are matched to a model of the plurality of models. A recommendation of components of the matching model is created to create the new storage subsystem.

### BACKGROUND

Embodiments of the invention relate to determining components of a storage subsystem based on measurements and models. Determining the components includes determining a size of the storage subsystem.

A storage subsystem has components for storing and processing data. When proposing a new storage subsystem for a client, a sizing for the new storage subsystem takes the expected workloads and the contemplated functions for the individual application workloads into account. Because the workloads share the resources of the storage subsystem, they interfere and cannot be treated separately.

Due to the complexity of estimating the size of the new storage subsystem, mathematical models are created to simulate the new storage subsystem. For each component of the new storage subsystem, characteristics, such as bandwidth and latency, are determined. For example, with the models, the utilization of each component of the storage subsystem is determined, and the latency and bandwidth for the expected workloads are derived.

A common practice is to inject multiple simplified workloads into the model, which characterizes the client's overall workload.

The subject matter expert parametrizes each expected workload, by, for example, analyzing available performance data or by making assumptions based on the client's requirements and workload description. For workloads which are already running at the client systems, the subject matter expert collects performance data, which is normally gathered in an interval of 5-10 minutes and shows rough overall characteristics, without representing short peak workloads. The quality of the parametrization of each workload differs with the skill of the subject matter expert, the available performance data, and how precisely the client defines the requirements in case no performance data is available.

### SUMMARY

In accordance with certain embodiments, a computer-implemented method comprising operations is provided for determining optimal components of a storage subsystem based on measurements and models. In such embodiments, data for a storage subsystem having a plurality of components is collected, where the data comprises data for application resources, data for workload measurements, metadata, tags, and policies, and wherein the data comprises volume specific characteristics and storage functions. A plurality of models are generated based on the collected data, where each of the models includes a subset of the plurality of components of the storage subsystem. Characteristics for a new storage subsystem are received. The characteristics are matched to a model of the plurality of models. A recommendation of components of the matching model is created to create the new storage subsystem.

In accordance with other embodiments, a computer program product comprising a computer readable storage medium having program code embodied therewith is provided, where the program code is executable by at least one processor to perform operations for model generation for determining optimal components of a storage subsystem based on measurements and models. In such embodiments, data for a storage subsystem having a plurality of components is collected, where the data comprises data for application resources, data for workload measurements, metadata, tags, and policies, and wherein the data comprises volume specific characteristics and storage functions. A plurality of models are generated based on the collected data, where each of the models includes a subset of the plurality of components of the storage subsystem. Characteristics for a new storage subsystem are received. The characteristics are matched to a model of the plurality of models. A recommendation of components of the matching model is created to create the new storage subsystem.

In accordance with yet other embodiments, a computer system comprises one or more processors, one or more computer-readable memories, other peripheral devises and one or more computer-readable, tangible storage devices; and program instructions, stored on at least one of the one or more computer-readable, tangible storage devices for execution by at least one of the one or more processors via at least one of the one or more memories, to perform operations for determining optimal components of a storage subsystem based on measurements and models. In such embodiments, data for a storage subsystem having a plurality of components is collected, where the data comprises data for application resources, data for workload measurements, metadata, tags, and policies, and wherein the data comprises volume specific characteristics and storage functions. A plurality of models are generated based on the collected data, where each of the models includes a subset of the plurality of components of the storage subsystem. Characteristics for a new storage subsystem are received. The characteristics are matched to a model of the plurality of models. A recommendation of components of the matching model is created to create the new storage subsystem.

### BRIEF DESCRIPTION OF THE SEVERAL VIEWS OF THE DRAWINGS

Referring now to the drawings in which like reference numbers represent corresponding parts throughout:

FIG. 1 illustrates a computing environment in accordance with certain embodiments.

FIGS. 2A and 2B illustrate, in a block diagrams, computing environments with a storage subsystem recommendation module and with one or more storage subsystems in accordance with certain embodiments.

FIG. 3 illustrates components and a flow of processing of the storage subsystem recommendation module in accordance with certain embodiments.

FIG. 4 illustrates model prediction and validation in accordance with certain embodiments.

FIG. 5 illustrates, in a flowchart, operations for determining optimal components of a storage subsystem based on measurements and models in accordance with certain embodiments.

FIG. 6 illustrates, in a flowchart, operations for validating a model in accordance with certain embodiments.

### DETAILED DESCRIPTION

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, host bus adapters, converged network adapters, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

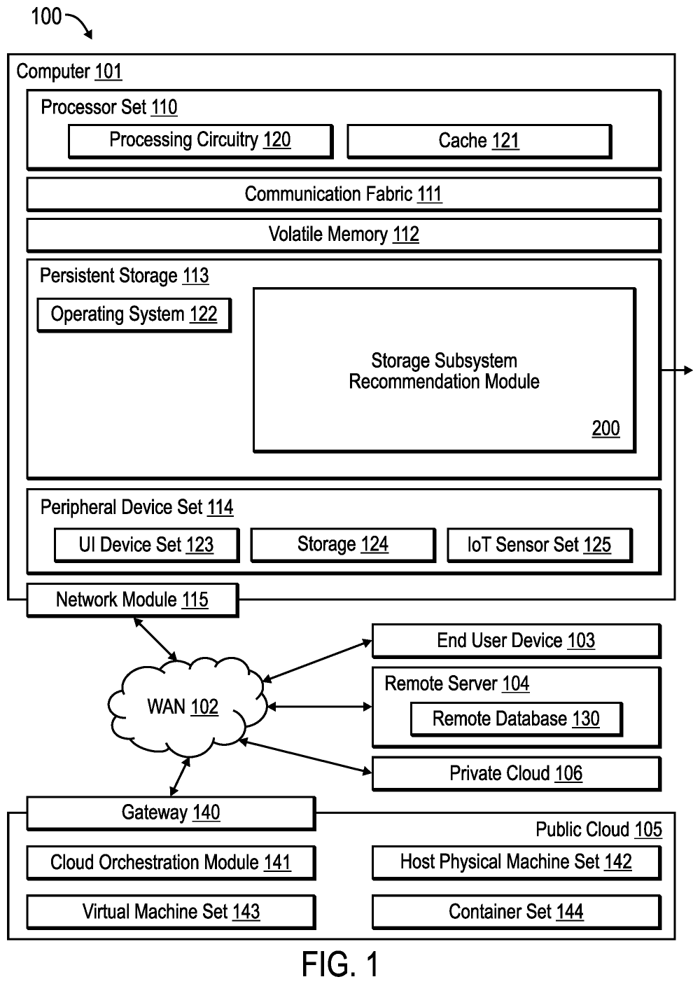

FIG. 1 illustrates a computing environment 100 in accordance with certain embodiments. Computing environment 100 contains an example of an environment for the execution of at least some of the computer code involved in performing the inventive methods, such as storage subsystem recommendation module 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), host bus adapters, converged network adapters, connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device.

In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

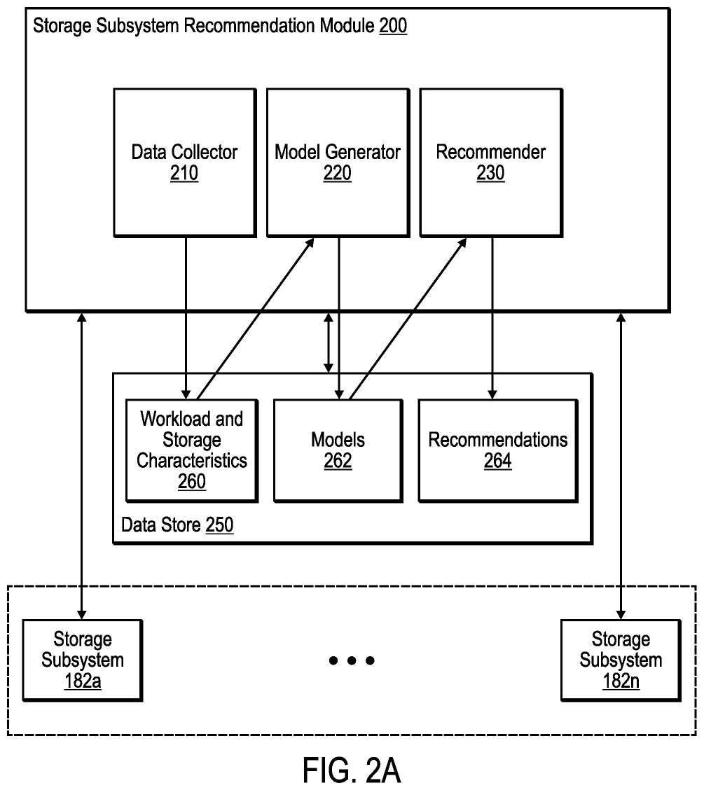

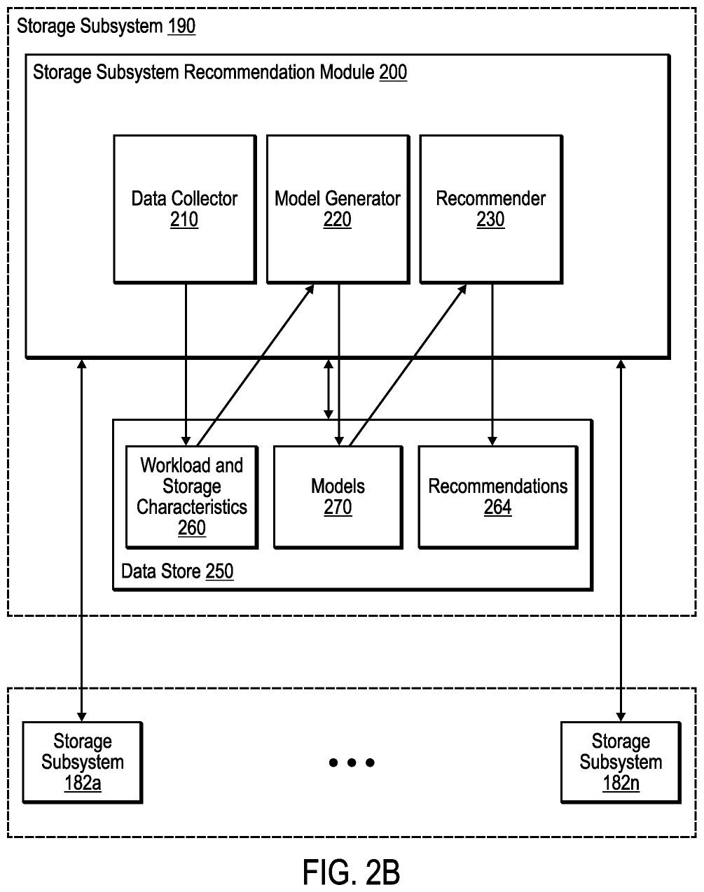

FIG. 2A illustrates, in a block diagram, a computing environment with a storage subsystem recommendation module 200 separate from one or more storage subsystems in accordance with certain embodiments. In FIG. 2A, the storage subsystem recommendation module 200 is connected to a data store 250 and to one or more storage subsystems 182a . . . 182n. The storage subsystem recommendation module 200 is part of the computer 101. The storage subsystem recommendation module 200 includes a data collector 210, a model generator 220, and a recommender 230. The data store 250 stores workload and storage characteristics 260, models 262, and recommendations 264. In certain embodiments, the models 262 are machine learning models or mathematical models.

In certain embodiments, the data collector 210 collects the workload and storage characteristics 260 of the one or more storage subsystems 182a . . . 182n and stores the workload and storage characteristics 260 in the data store 250. The model generator 220 uses the workload and storage characteristics 260 to generate models 262 and store the models in the data store 250. The recommender 230 uses the models 262 to generate one or more recommendations 264 and stores the one or more recommendations 264 in the data store 250. The recommendation may identify components for a new storage subsystem or may identify components to add and/or remove for an existing storage subsystem 182a . . . 182n. Each of the components may be a hardware component or a software component (e.g., an application). Based on a recommendation for a storage subsystem, a new storage subsystem may be built or an existing storage subsystem 182a . . . 182n may be updated (e.g., with components added and/or removed).

Simulation modeling may be described as a process of creating and analyzing the model to predict its performance in the real world. In certain embodiments, once the models are generated, the model generator 220 may apply different configurations to a model to simulate different real world conditions. For example, a storage subsystem may be adapted in multiple ways. One configuration may use faster Central Processing Units (CPUs) if the processing of the data in the controller is a bottleneck. Another configuration may use more storage devices (e.g., hard drives and Solid State Drives (SSDs) to enhance the backend storage. Yet another configuration may use larger caches to reduce the amount of accesses to the storage backend.

FIG. 2B illustrates, in a block diagrams, a computing environment with a storage subsystem recommendation module 200 being a part of a storage subsystem 190 and, optionally, connected to one or more storage subsystems in accordance with certain embodiments. In FIG. 2B, the storage subsystem recommendation module 200 executing on a computer 110 is part of one storage subsystem 190. In certain embodiments, the storage subsystem recommendation module 200 may be part of the storage subsystem 190 (e.g., for easier data collection). In this embodiment, the data collector 210 of the storage subsystem recommendation module 200 collects data (i.e., the workload and storage characteristics 260) from the storage subsystem 190 and, optionally, from the one or more storage subsystems 182a . . . 182n. Then, the model generator 220 of the storage subsystem recommendation module 200 uses the workload and storage characteristics 260 to generate one or more models. The recommender 230 uses the one or more models to provide one or more recommendations. The recommendation may identify components for a new storage subsystem or may identify components to add and/or remove for an existing storage subsystem 182a . . . 182n, 190.

The storage subsystems 182a . . . 182n. 190 may be enterprise storage subsystems that provide storage capacities within datacenters. The storage capacity of each storage subsystem 182a . . . 182n, 190 is shared between many servers. Each server may use storage of one or more of the storage subsystems 182a . . . 182n. 190. For individual workloads, volumes (e.g., Logical Units) or filesystems are assigned to the servers where that individual workload is running.

In the storage subsystems 182a . . . 182n. 190, multiple techniques may be used to optimize provided capacity. These include, for example, thin provisioning, compression, and deduplication. Also, protections, such as snapshots and replication to other storage subsystems or cloud services, are provided by each of the storage subsystems 182a . . . 182n. 190 . . . . These functions put additional load on the controllers of the storage subsystems 182a . . . 182n, 190 and enhance the Input/Output (IO) density on the backend storage. In certain embodiments, if a workload uses multiple storage subsystems 182a . . . 182n, 190, there is appropriate coordination of the functions of the multiple storage systems 182a . . . 182n to provide consistency.

The storage subsystems 182a . . . 182n, 190 use shared components for the storage capacity they provide. Therefore, the capability of each component is limited. These components include, for example, controllers with Central Processing Unit (CPU), memory, Peripheral Component Interconnect (PCI) busses, Interface Cards, and storage devices. Many of these components may show non-linear behavior as they reach their limits.

The storage subsystem recommendation module 200 provides reproduceable results and quality assurance for sizing new storage subsystems or modifying existing storage subsystems. With embodiments, the storage subsystem recommendation module 200 replaces workload estimations and assumptions with measurements.

The storage subsystem recommendation module 200 enhances the quality of the application workload characterization by measuring the workload characteristics instead of using estimations. With embodiments, the storage subsystem recommendation module 200 performs one or more of the following measurements:
1) Measurements on the storage subsystem, which include adapting the data collection intervals to the workload. The data collection interval may be described as a period in which an average of the collected data is computed.
2) Application resource management performance measurements.
3) Host-based performance measurements if 1) or 2) are not available.

For workloads where measurements are not able to be performed (e.g., new workloads), the storage subsystem recommendation module 200 may use manual workload characterization.

To enhance the measurements with metadata, the storage subsystem recommendation module 200 leverages:
1) automatic determination of storage functions (i.e., storage specific functions) used with key characteristics for the model;
2) automatic application resource management tagging; and
3) manual tagging of volumes/workloads.

The storage subsystem recommendation module 200 enables the workload characterization to be more accurate and to include volume specific characteristics that are normally taken from good practices.

Additionally, the storage subsystem recommendation module 200 retrieves controller characteristics (e.g., cache utilization and hit ratios) per volume or workload, and the measurements detect low, medium, and peak workloads. Such peak workloads are normally hidden by averaging over the data collection interval in conventional techniques. That is, the larger the data collection interval, the more outliers that may not be detected and are included in the average.

Based on detecting low, medium, and peak workloads for each volume in the storage subsystems, the data collector 210 dynamically adjusts the data collection interval to detect outliers. With the detection of low, medium, and peak workloads for each volume in the storage subsystems, the storage subsystem recommendation module 200 defines accurate distributions and skews that may be leveraged by model simulation.

Client storage subsystems that are not implementing the storage subsystem recommendation module 200 may be attached to a storage subsystem that is capable of storage virtualization. In this way the storage subsystem recommendation module 200 has been placed in the data path and is able to gather the data necessary for the storage subsystem recommendation module 200. Then, the workload at the client may be measured with any type of storage subsystem.

In certain embodiments, the storage subsystem recommendation module 200 enhances the traditional storage subsystem sizing process. In particular, the storage subsystem recommendation module 200 replaces workload estimation with workload measurement (directly on an existing storage subsystem, via application resource management of the host). In addition, the storage subsystem recommendation module 200 allows for variable workload measurement data collection intervals to detect outliers (e.g., after detecting low, medium, and peak points, the storage subsystem recommendation module 200 may adjust the data collection interval). Also, the storage subsystem recommendation module 200 obtains measurement of characteristics of storage functions (e.g., compression, deduplication, etc.). Moreover, the storage subsystem recommendation module 200 uses workload tags (e.g., Service Level Agreement (SLA) tags, prioritization tags, etc.). The storage subsystem recommendation module 200 provides direct measurement of each storage function induced load on each storage component. The storage subsystem recommendation module 200 also optimizes the model of the storage subsystem that prescribes a workload threshold index (e.g., low, medium, high/peak). In addition, the storage subsystem recommendation module 200 validates the model on a plurality of systems running live workloads.

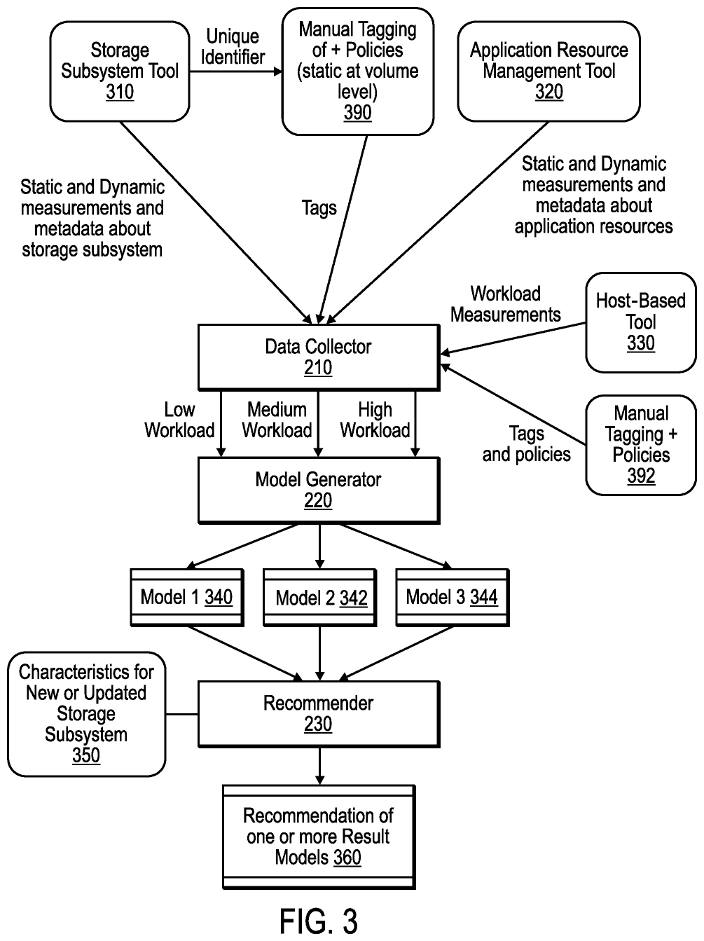

FIG. 3 illustrates components and a flow of processing of the storage subsystem recommendation module 200 in accordance with certain embodiments. A storage subsystem tool 310 collects and sends data (i.e., static and dynamic measurements and metadata) for the storage subsystem to the data collector 210 of the storage subsystem recommendation module 200. In certain embodiments, each storage subsystem has a storage subsystem tool 310. In other embodiments, a storage subsystem tool 310 collects the static and dynamic measurements and metadata for multiple storage subsystems. In certain embodiments, the storage subsystem tool 310 collects static data that includes size of the storage subsystem, hosts in the storage subsystem, connections in the storage subsystem, etc. In certain embodiments, the storage subsystem tool 310 collects dynamic data that includes the number of read operations performed in the storage subsystem, the read latency, the number of write operations performed in the storage subsystem, the write latency, block size, read cache hit ratio, sequential Input/Output (IO), etc. In certain embodiments, the storage subsystem tool 310 also collects the compression ratio of data stored (in compressed format) in the storage subsystem and the utilization trend of the storage. The storage subsystem tool 310 also generates a unique identifier for each volume and sends the unique identifier to the manual tagging block 390. The storage subsystem tool 310 generates other metadata, such as static characteristics of the storage subsystem like but not limited to installed memory, number and types of CPU, number and type of storage devices, PCIe lanes, adapter cards and measurements like but not limited to actual utilization for CPU, memory usage for read and write cache, memory usage per volume, adapter bandwidth, adapter latencies, queue usage.

The manual tagging block 390 indicates that a system administrator may add manual tags and policies (e.g., SLA, etc.) using the unique identifier, and such tagging is static at volume level.

The application resource management tool 320 collects and sends static and dynamic data (e.g., measurements and metadata) for application resources to the data collector 210 of the storage subsystem recommendation module 200. In certain embodiments, the application resource management tool 320 collects data about which application is using which volume and/or database and application latency. The metadata may include identification of each application, each volume, each database, etc.

The host-based tool 330 collects measurements about workloads on storage subsystems not directly measured by the data collector 210. This includes, but is not limited to, amounts of reads and writes to the individual volumes, the block size, the bandwidth of the data stream and the individual latencies induced. For known applications, the host-based tool 330 may automatically tag the volumes with application specifics, such as database files and redo logs.

The manual tagging block 392 indicates that a system administrator may add manual tags and policies (e.g., SLA, etc.) using the unique identifier. These tags are rather workload driven and complement the measurements that are done on the volume base in the block 330.

The data collector 210 collects the data that includes the measurements and metadata about the storage subsystem, the measurements and metadata about the application resources. The data collector 210 uses the data to determine low workloads, medium workloads, and peak workloads. Based on the low workloads, medium workloads, and peak workloads, the data collector 210 may change the data collection interval. The data collector 210 sends data for the low workloads, medium workloads, and peak workloads to the model generator 220 of the storage subsystem recommendation module 200.

The model generator 220 feeds simulation models, such as model 1 340, model 2 342, and model 3 344 with the gathered data. Each of the models 340, 342, 344 has a different configuration based on storage controller and storage configuration. The results of the models 340, 342, 344 are used by the recommender 230 of the storage subsystem recommendation module 200.

In certain embodiments, the data is collected from an existing storage subsystem, which has different components (e.g., a certain number of volumes of storage). Then, each of the models 340, 342, 344 has some subset of these components and may have additional components (i.e., not in the existing storage subsystem). In certain embodiments, the subset may include one of the components to all of the components.

The recommender 230 also receives desired characteristics 350, which may be, for example, but not limited to, latency for the workload, price, or price/performance for a new storage subsystem or for an updated existing storage subsystem. The recommender 230 then matches the characteristics to one or more of the models 240, 242, and 244 and outputs one or more recommendation models 250. Each of the recommendation models 250 includes components, and an existing storage subsystem may be updated or a new storage subsystem may be created using the components.

For a storage subsystem, the characteristics for the active workloads are directly recorded during runtime. Each active workload induced by an application is located on one or more volumes. In certain embodiments, the data collector 210 provides inputs to the model generator 220, and the inputs are used to simulate new storage subsystems or updated existing storage subsystems.

In certain embodiments, the storage subsystem tool 310 collects the inputs, which include but are not limited to: an IO rate, a read/write ratio, a read block size, a write block size, a read cache hit ratio, a write cache hit ratio, a read latency, a write latency, a read skew and density, a write skew and density, compression ratio, and a deduplication ratio.

In certain embodiments, to group the individual volumes into a workload of an application, multiple tagging is supported. As an example, two different approaches are listed:
1. Manual workload tagging based on the individual volumes. Additional SLA tagging (e.g., platinum, gold, silver, and bronze) for workload prioritization (390, 392).
2. Automatic workload tagging using the application resource management tool 320.

In addition to the workload tagging, the application resource management tool 320 provides application measurements and tags that may be used to optimize the final model selection.

The data collector 210 aggregates the volume measurements for the individual workloads. Additionally, the usage data of the components of the storage subsystem are be collected and respective components are be identified as they are approaching their maximum performance.

In certain embodiments, because the data collector 210 is part of the storage subsystem, the granularity of the aggregation time may be varied based on the amounts of IOs. For low IO rates corresponding to low workloads, the data collector 210 may select a long aggregation time. For medium IO rates corresponding to medium workloads, the data collector 210 may use a default aggregation time. For high IO rates corresponding to high workloads, the data collector may use a fine granular aggregation time. In this manner, the data collector 210 detects outliers without having to record all data with fine granularity. In addition to the aggregated values, for each aggregation interval, the data collector 210 includes the minimum/maximum values for each characteristic and a fitted distribution of the values.

For workloads which are not connected to the storage subsystem tool 310 or the application resource management tool 320, the host-based tool 330 is used to measure workload characteristics on different storage subsystems. In addition, the manual tagging block 392 may be used to specify the workload. This feature may be used for consolidation purposes or repatriation of cloud workloads to on-prem environments.

In certain embodiments, the model generator 220 may be described as a storage subsystem simulation module. Depending on the use case, the model generator 220 may or may not be running on the storage controller of a particular storage subsystem. If the model generator 220 is running as a service outside the storage subsystem, the measurement data may be uploaded in an automatic or manual way to the model generator 220.

The model generator 220 leverages multiple sets of inputs, such as:
1. measured workload characteristics from one or more storage subsystems that are running;
2. manual defined workload characteristics; and
3. planned features to be used for each workload (e.g., compression, deduplication, snapshots, replication, etc.).

In certain embodiments, the model generator 220 uses the inputs to simulate different configurations of storage subsystems. In certain embodiments, the selection of different configuration of storage subsystems may be based on inputs (e.g., from a system administrator) or may be based on leveraging good practices for low latency configurations or high capacity configurations.

In certain embodiments, the recommender 230 evaluates the result of these simulations automatically based on the utilization of the storage subsystems on low, medium, and high workloads and the headroom which is calculated based on the expected growth over the expected lifetime of the storage subsystem up to an expected non-linear response.

By removing many estimations of the application workloads, the storage subsystem recommendation module 200 generates reproduceable results and enhances the quality of the sizing of the storage subsystem.

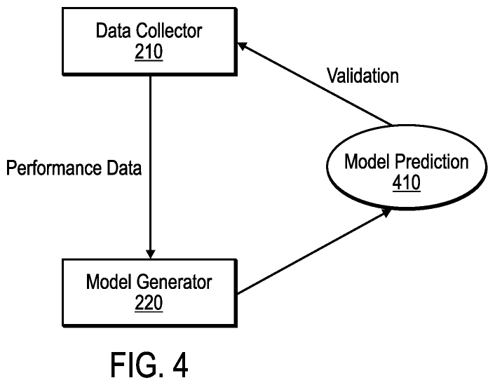

FIG. 4 illustrates model prediction and validation in accordance with certain embodiments. Beside the sizing of new storage subsystems and updated existing storage subsystems, the storage subsystem recommendation module 200 also enables the validation of the storage subsystem model, which represents the actual storage subsystem.

For a given workload, the model generator 220 creates a model, which predicts the utilization of the individual components of the existing storage subsystem from which data has been collected. The model generator 220 takes into account the performance data (e.g., response times of the IOs) from the data collector 210 and validates the results against the measured performance data. If the measurements differ to a large extent from the model, the data may be sent back to the development team so that the model may be adjusted. In this way, there is a quick turnaround for the development of the models to be implemented, and a field validation of the models is performed. This leads to more accurate models, which are leveraged to create actual storage subsystems.

By increasing the characterization of application workloads and adding storage subsystem measurements of the storage controller utilization, the storage subsystem recommendation module 200 provides results from the model simulation that are more precise. This provides confidence that the model fulfills the desired characteristics (e.g., requirements) of the updated or new storage subsystem. With this, the clients have more confidence that the workload requirements are satisfied by the updated or new storage subsystem. In addition, with a more precise sizing of the updated or new storage subsystem, technical sales entities are able to optimize proposals by focusing on: cost savings, performance enhancement/faster results from workloads, sustainability/eco-energy savings, and higher confidence for the recommended storage subsystem solution.

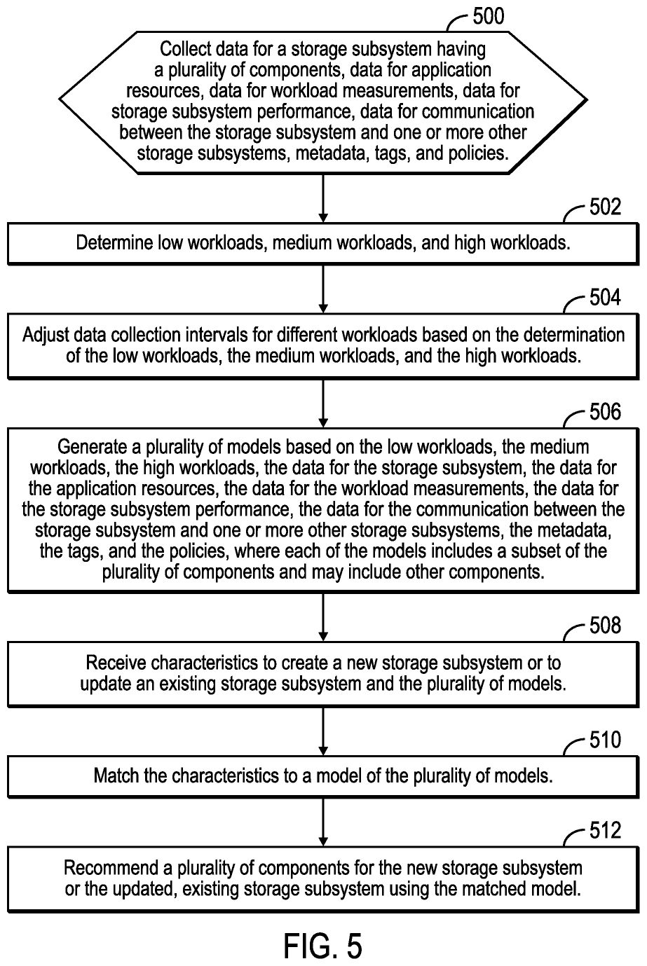

FIG. 5 illustrates, in a flowchart, operations for determining optimal components of a storage subsystem based on measurements and models in accordance with certain embodiments. Determining optimal components of a storage subsystem may be described as determining the components of the storage subsystem based on the measurements of one or more existing models and characteristics desired for creating a new storage subsystem or updating an existing storage subsystem. Control begins at block 500 with the data collector 210 of the storage subsystem recommendation module 200 collecting data for a storage subsystem having a plurality of components, data for application resources, data for workload measurements, data for storage subsystem performance, data for communication between the storage subsystem and one or more other storage subsystems, metadata, tags, and policies. In block 502, the data collector 210 determines low workloads, medium workloads, and high workloads based on the collected data. In certain embodiments, the data collector 210 may also determine that there are no workloads. In certain embodiments, the data collector 210 determines one or more of the low workloads, the medium workloads, and the high workloads based on the collected data.

In block 504, the data collector 210 adjusts the data collection intervals for different workloads (low, medium, and/or high) based on the determination of the low workloads, medium workloads, and high workloads.

In block 506, the model generator 220 of the storage subsystem recommendation module 200 generates a plurality of models based on the workloads (i.e., the low workloads, the medium workloads, and/or the high workloads), the data for the storage subsystem, the data for the application resources, the data for the workload measurements, the data for the storage subsystem performance, the data for the communication between the storage subsystem and one or more other storage subsystems, the metadata, the tags, and the policies, where each of the models includes a subset of the plurality of components and may include other components (i.e., not part of the storage subsystem).

In block 508, the recommender 230 of the storage subsystem recommendation module 200 receives characteristics to create a new storage subsystem or to update an existing storage subsystem and the plurality of models. In block 510, the recommender 230 matches the characteristics to a model of the plurality of models. In block 512, the recommender 230 recommends a plurality of components for the new storage subsystem or the updated, existing storage subsystem using the matched model.

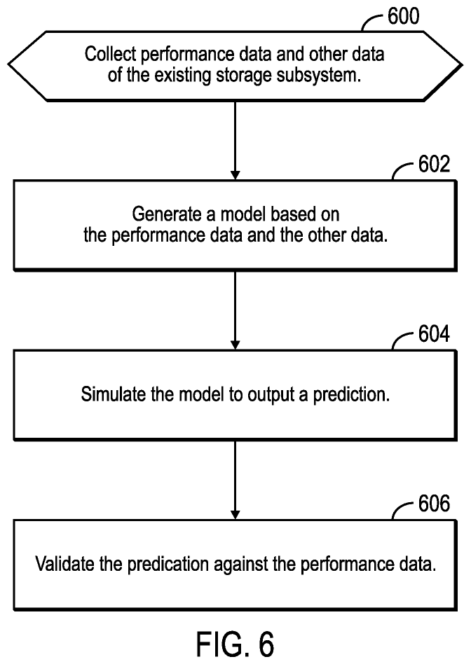

FIG. 6 illustrates, in a flowchart, operations for validating a model in accordance with certain embodiments. Control begins at block 600 with the data collector 210 collecting performance data and other data of the existing storage subsystem. In block 602, the model generator 220 generates a model based on the performance data and the other data. In block 604, the model generator 220 simulates the model to output a prediction. In block 606, the model generator 220 validates the prediction (e.g., workload latency or CPU utilization) against the performance data.

With embodiments, the storage subsystem recommendation module 200 collects measurements and metadata, generates models based on the collected measurements and metadata, and provides recommendations using the models and desired characteristics.

The terms “an embodiment”, “embodiment”, “embodiments”, “the embodiment”, “the embodiments”, “one or more embodiments”, “some embodiments”, and “one embodiment” mean “one or more (but not all) embodiments of the present invention(s)” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

In the described embodiment, variables a, b, c, i, n, m, p, r, etc., when used with different elements may denote a same or different instance of that element.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present invention need not include the device itself.

The foregoing description of various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, embodiments of the invention reside in the claims herein after appended. The foregoing description provides examples of embodiments of the invention, and variations and substitutions may be made in other embodiments.

1. A computer-implemented method, comprising operations for:
collecting data for a storage subsystem having a plurality of components, wherein the collected data comprises data for application resources, data for workload measurements, metadata, tags, and policies, and wherein the collected data comprises volume specific characteristics and storage functions;
determining low workloads, medium workloads, and high workloads;
generating a plurality of models based on the collected data and based on the low workloads, the medium workloads, and the high workloads, wherein each of the models includes a subset of the plurality of components of the storage subsystem, and wherein each of the models comprises a machine learning model;
receiving characteristics for a new storage subsystem;
matching the characteristics to a model of the plurality of models; and
providing a recommendation of components of the matching model to create the new storage subsystem, wherein the new storage subsystem is created using the recommended components.

2. The computer-implemented method of claim 1, further comprising operations for:
adjusting a data collection interval to detect outliers for different workloads based on the determination of the low workloads, the medium workloads, and the high workloads.

3. The computer-implemented method of claim 1, further comprising operations for:
receiving new characteristics to update an existing storage subsystem;
matching the new characteristics to a model of the plurality of models; and
providing a new recommendation of components of the matching model to update the existing storage subsystem.

4. The computer-implemented method of claim 1, further comprising operations for:
simulating different configurations of the storage subsystem with different inputs to the plurality of models.

5. The computer-implemented method of claim 1, further comprising operations for:
validating the matching model using performance data.

6. The computer-implemented method of claim 1, wherein the collected data comprises measurements of the storage subsystem while the storage subsystem is running workloads.

7. The computer-implemented method of claim 1, wherein a component of the components comprises one of a hardware component and a software component.

8. A computer program product, the computer program product comprising a computer readable storage medium having program instructions embodied therewith, the program instructions executable by a processor to cause the processor to perform operations for:
collecting data for a storage subsystem having a plurality of components, wherein the collected data comprises data for application resources, data for workload measurements, metadata, tags, and policies, and wherein the collected data comprises volume specific characteristics and storage functions;
determining low workloads, medium workloads, and high workloads;
generating a plurality of models based on the collected data and based on the low workloads, the medium workloads, and the high workloads, wherein each of the models includes a subset of the plurality of components of the storage subsystem, and wherein each of the models comprises a machine learning model;
receiving characteristics for a new storage subsystem;
matching the characteristics to a model of the plurality of models; and
providing a recommendation of components of the matching model to create the new storage subsystem, wherein the new storage subsystem is created using the recommended components.

9. The computer program product of claim 8, wherein the program instructions are executable by the processor to cause the processor to perform operations for:
adjusting a data collection interval to detect outliers for different workloads based on the determination of the low workloads, the medium workloads, and the high workloads.

10. The computer program product of claim 8, wherein the program instructions are executable by the processor to cause the processor to perform operations for:
receiving new characteristics to update an existing storage subsystem;
matching the new characteristics to a model of the plurality of models; and
providing a new recommendation of components of the matching model to update the existing storage subsystem.

11. The computer program product of claim 8, wherein the program instructions are executable by the processor to cause the processor to perform operations for:
simulating different configurations of the storage subsystem with different inputs to the plurality of models.

12. The computer program product of claim 8, wherein the program instructions are executable by the processor to cause the processor to perform operations for:
validating the matching model using performance data.

13. The computer program product of claim 8, wherein the collected data comprises measurements of the storage subsystem while the storage subsystem is running workloads.

14. The computer program product of claim 8, wherein a component of the components comprises one of a hardware component and a software component.

15. A computer system, comprising:
one or more processors, one or more computer-readable memories and one or more computer-readable, tangible storage devices; and
program instructions, stored on at least one of the one or more computer-readable, tangible storage devices for execution by at least one of the one or more processors via at least one of the one or more computer-readable memories, to perform operations comprising:
collecting data for a storage subsystem having a plurality of components, wherein the collected data comprises data for application resources, data for workload measurements, metadata, tags, and policies, and wherein the collected data comprises volume specific characteristics and storage functions;
determining low workloads, medium workloads, and high workloads;
generating a plurality of models based on the collected data and based on the low workloads, the medium workloads, and the high workloads, wherein each of the models includes a subset of the plurality of components of the storage subsystem, and wherein each of the models comprises a machine learning model;
receiving characteristics for a new storage subsystem;
matching the characteristics to a model of the plurality of models; and
providing a recommendation of components of the matching model to create the new storage subsystem, wherein the new storage subsystem is created using the recommended components.

16. The computer system of claim 15, wherein the program instructions further perform operations comprising:
adjusting a data collection interval to detect outliers for different workloads based on the determination of the low workloads, the medium workloads, and the high workloads.

17. The computer system of claim 15, wherein the program instructions further perform operations comprising:
receiving new characteristics to update an existing storage subsystem;
matching the new characteristics to a model of the plurality of models; and
providing a new recommendation of components of the matching model to update the existing storage subsystem.

18. The computer system of claim 15, wherein the program instructions further perform operations comprising:
simulating different configurations of the storage subsystem with different inputs to the plurality of models.

9. The computer system of claim 15, wherein the program instructions further perform operations comprising:
validating the matching model using performance data.

20. The computer system of claim 15, wherein the collected data comprises measurements of the storage subsystem while the storage subsystem is running workloads.
